(19) United States
(12) Patent Application Publication
(10) Pub. No.: US 2026/0236752 A1
(43) Pub. Date: Aug. 13, 2026

(54) MULTI-TENANT HUB AND SPOKE ARCHITECTURE FOR DISTRIBUTED GENERATIVE AI APPLICATIONS IN INDUSTRIAL ENVIRONMENTS

(71) Applicants: Anil Chandrupatla, San Jose, CA (US); Sonu Pandiyath Sudhakaran, Bangalore (IN); Shreyash Sridhar Iyengar, San Francisco, CA (US); Savinay Chandrupatla, San Jose, CA (US); Tejaswi Rajeevalochanam, Bangalore (IN)

(72) Inventors: Anil Chandrupatla, San Jose, CA (US); Sonu Pandiyath Sudhakaran, Bangalore (IN); Shreyash Sridhar Iyengar, San Francisco, CA (US); Savinay Chandrupatla, San Jose, CA (US); Tejaswi Rajeevalochanam, Bangalore (IN)

(21) Appl. No.: 19/459,699

(22) Filed: Jan. 26, 2026

Related U.S. Application Data
(60) Provisional application No. 63/756,494, filed on Feb. 10, 2025.

(51) Int. Cl. G06N 3/0475; H04L 9/40

(52) U.S. Cl. CPC G06N 3/0475; H04L 63/0471

(57) ABSTRACT

A distributed system for deploying and operating generative AI applications within constrained industrial environments comprises a central hub in a centralized data center. The central hub hosts a foundation model hosting layer with compute infrastructure for executing foundation models, a global data aggregation layer for storing global contextual data and aggregated summaries from spoke locations, and an agent orchestration module for routing queries and consolidating responses from spokes. Decentralized spokes at industrial sites host a local data ingestion layer for collecting operational data, an edge compute unit for lightweight AI agent inference, and a local contextual data store enabling low-latency inference. An authenticated private link connects each spoke to the central hub for secure, encrypted data transfer.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### CROSS REFERENCE TO RELATED APPLICATIONS

This application is a Continuation-In-Part Utility Patent application claiming priority to U.S. patent application Ser. No. 19/457,545, filed on Jan. 23, 2026, this application is a Continuation-In-Part Utility Patent application claiming priority to U.S. patent application Ser. No. 19/454,155, filed on Jan. 20, 2026, which in turn claims the benefit of U.S. Provisional patent Application Ser. No. 63/756,494, filed on Feb. 10, 2025, both of which are incorporated by reference herein in their entirety.

### BACKGROUND OF THE INVENTION

### 1) Field of the Invention

The invention relates in general to the field of distributed computing architectures for generative artificial intelligence applications, and more particularly to a multi-tenant hub and spoke architecture for deploying and operating generative AI agents within constrained industrial and manufacturing environments having limited power, cooling, and network infrastructure.

### 2) Description of Related Art

Currently the state of the art includes numerous systems designed to improve systems for controlling manufacturing and industrial environments.

The landscape of Generative Artificial Intelligence (GenAI) presents transformative opportunities for industrial use cases, particularly within manufacturing and factory environments. Modern factory floors are complex ecosystems characterized by numerous interconnected pieces of equipment, devices, and sensors. These assets perform diverse operations, ranging from precision machining and assembly to quality control and logistics. A core feature of this environment is the continuous, high-volume data generation from these devices, often referred to as data loggers. This operational data—including sensor readings, performance metrics, fault codes, and utilization statistics—is typically aggregated and managed by data acquisition systems such as Supervisory Control and Data Acquisition (SCADA) systems, which serve as central control hubs enabling operators to monitor, manage, and optimize production processes.

In addition to automated data logs, manufacturing environments rely heavily on human-generated data, such as manual inspection reports, maintenance journals, operational notes, and shift logs. These unstructured manufacturing records contain valuable context, observations, and expert knowledge. To leverage GenAI capabilities, these handwritten or manually entered records are digitized, captured, and structured for integration into AI model training and inference pipelines. The application of Generative AI in this context is aimed at creating novel insights, automating complex decision-making, and developing predictive models for maintenance, quality assurance, and operational efficiency.

A constraint in deploying advanced AI in industrial settings is the factory floor environment itself. These industrial settings are frequently suboptimal for hosting large-scale computing infrastructure. Power and cooling limitations present challenges, as industrial sites often lack the robust, high-capacity electrical infrastructure and dedicated cooling systems to support the power draw of large-scale GPU clusters used for GenAI model training and inference. Many facilities lack dedicated, climate-controlled server rooms, and high levels of dust, temperature fluctuation, and vibration can compromise standard data center hardware.

Network latency and bandwidth present additional challenges. While local area networks exist within industrial facilities, pushing massive amounts of raw, high-frequency data to a central cloud location for immediate processing introduces latency, which may be unacceptable for real-time control applications. Lack of consistent, high-speed internet or intermittent network availability is a concern, impacting reliance on cloud-based solutions for real-time control applications.

Security and data sovereignty considerations also affect deployment decisions. Many organizations prefer to keep sensitive operational data within their local network boundaries through edge computing approaches for security and compliance reasons. The hybrid nature of industrial deployments further complicates architecture decisions. Industrial architecture may benefit from a hybrid data approach where local edge processing handles time-sensitive, high-volume, proprietary operational data such as sensor readings and logs to minimize latency and address security concerns, while global contextual data including benchmarks, historical records, and public data along with large foundation models reside in centralized cloud infrastructure for centralized computation.

This dichotomy of computational demands of data-intensive GenAI models versus the physical constraints of industrial environments-presents challenges for conventional centralized GenAI architectures. Distributed, efficient, and secure solutions that can address these competing requirements while maintaining operational effectiveness across multiple independent factory tenants would be beneficial in the field.

These and other objects, features, and advantages of the present invention will become more readily apparent from the attached drawings and the detailed description of the preferred embodiments, which follow.

### SUMMARY OF THE INVENTION

Bearing in mind the problems and deficiencies of the prior art, it is therefore an object of the present invention to provide a distributed system for deploying and operating generative artificial intelligence applications within constrained industrial environments.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a distributed system for deploying and operating Generative AI (GenAI) applications within constrained industrial environments is provided. The system includes a central Hub located in a centralized data center. The central Hub is configured to host a high-capacity Foundation Model (FM) hosting layer, including GPU/compute infrastructure unsuitable for industrial sites. The central Hub is configured to host a Global Data Aggregation and Contextualization Layer for storing and indexing global contextual data and aggregated summaries from multiple Spoke locations, including a Vector Database for Retrieval-Augmented Generation (RAG). The central Hub is configured to host an Agent Orchestration and Routing Module to securely route user queries and execute Hub-level “Meta-Agent” functionality, including grading, synthesizing, and consolidating responses from multiple Spokes. The central Hub is configured to implement a Multi-tenant Isolation and Governance Layer to enforce logical and computational separation between different factory tenants. The system includes one or more decentralized Spokes; each located at an industrial or factory site with power and cooling limitations. Each Spoke is configured to host a Local Data Ingestion Layer for collecting high-frequency, proprietary operational data from local sources including SCADA, PLCs, sensors, and production logs, including digitizing and structuring unstructured manual records. Each Spoke is configured to host an Edge Compute Unit, such as a hardened appliance with TPUs, configured to execute inference for lightweight, specialized AI Agents and perform immediate data pre-processing and feature extraction tasks. Each Spoke is configured to host a Local Contextual Data Store for storing recent, high-volume operational data to enable low-latency inference by local agents. The system includes an Authenticated Private Link connecting each Spoke to the Hub, ensuring secure, high-throughput, encrypted data transfer for inference requests and responses.

According to other aspects of the present disclosure, the lightweight, specialized AI Agents deployed at the Spoke may be configured to perform Low-Latency Decision-Making directly on real-time Edge data for functions such as predictive maintenance and immediate quality checks. The AI Agents may execute an agent-chain encompassing local data retrieval, ranking, and evaluation before sending a compressed response back to the Hub. The AI Agents may utilize compressed, distilled, or quantized versions of the Foundation Model to execute inference with minimal computational overhead on available Edge hardware. The AI Agents may access Local Tooling to directly interface with real-time local data and to call into the Hub's data services to consume aggregated global contextual data, enabling robust, hybrid decision-making.

According to other aspects of the present disclosure, the Multi-tenant Isolation and Governance Layer at the Hub may be further configured to enforce strict logical and computational separation of data and requests originating from different factory tenants throughout the system. The Multi-tenant Isolation and Governance Layer may manage user authentication (AuthN) and authorization (AuthZ) to ensure users can access GenAI results derived from their permitted Spoke data. The Multi-tenant Isolation and Governance Layer may provide centralized logging, auditing, and compliance reporting across all connected Spokes.

According to other aspects of the present disclosure, the system may further include an Asynchronous Communication Module. The Asynchronous Communication Module may be configured to utilize a store-and-forward mechanism within the Secure Communication Module at the Spoke to buffer non-time-critical data transfer, such as aggregated summaries and model updates, during network outages. The Asynchronous Communication Module may enable operational continuity and batch-oriented communication for non-critical data transfer, mitigating the impact of intermittent network availability or low-bandwidth conditions between the Spoke and the Hub. The Asynchronous Communication Module may ensure the Secure Communication Gateway at the Hub terminates the authenticated Private Links, managing high-throughput, encrypted data flow and implementing rate limiting.

According to another aspect of the present disclosure, a method for utilizing Generative AI in a multi-tenant industrial environment is provided. The method includes Local Data Curation and Feature Engineering at a Spoke, comprising ingesting high-volume, proprietary operational data and using the lightweight AI Agents to pre-process, structure manual records, anonymize, and extract features from the local data, thereby reducing the data volume. The method includes Local Inference Execution at the Spoke, comprising executing time-sensitive inference requests locally using the lightweight AI Agents and the Local Contextual Data Store to achieve millisecond-level latency for operational control. The method includes Complex Task Delegation from the Spoke to the Hub, comprising, when a Spoke AI agent encounters a task exceeding its local reasoning capability, initiating a request to the Hub and sending relevant local context to the Model interface deployed at the Hub for processing by the Hub's more complex Foundation Models. The method includes Centralized Request Routing and Synthesis at the Hub, comprising receiving a user query at the Hub, securely routing it to one or more appropriate Spokes, receiving responses from the selected Spoke Agents, executing the Hub-level “Meta-Agent” to grade and consolidate the responses, and generating a single, unified answer for the user.

The foregoing general description of the illustrative embodiments and the following detailed description thereof are merely exemplary aspects of the teachings of this disclosure and are not restrictive.

Still other objects and advantages of the invention will in part be obvious and will in part be apparent from the specification.

The above and other objects, which will be apparent to those skilled in the art, are achieved in the present invention which is directed to a distributed system for deploying and operating generative artificial intelligence applications within constrained industrial environments, comprising:
a. a central hub located in a centralized data center, the central hub configured to host a foundation model hosting layer including compute infrastructure for executing foundation models, to host a global data aggregation layer for storing and indexing global contextual data and aggregated summaries from a plurality of spoke locations, and to host an agent orchestration module configured to route user queries and to grade, synthesize, and consolidate responses received from a plurality of spokes;
b. a plurality of decentralized spokes, each spoke located at an industrial site and configured to host a local data ingestion layer for collecting operational data from local sources, to host an edge compute unit configured to execute inference for lightweight AI agents, and to host a local contextual data store for storing operational data to enable low-latency inference by the lightweight AI agents; and
c. an authenticated private link connecting each spoke of the plurality of decentralized spokes to the central hub, the authenticated private link configured to provide secure, encrypted data transfer for inference requests and responses between each spoke and the central hub.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 illustrates a deployment structure for a multi-tenant hub and spoke architecture, according to aspects of the present disclosure.

FIG. 2 illustrates a sequence diagram depicting interactions between AI agents at a spoke and a hub, according to an embodiment.

FIG. 3 illustrates deployment form factors for a hub-spoke AI agent deployment system with data fabric integration, according to aspects of the present disclosure.

FIG. 4 illustrates a block diagram of a hub and spoke architecture for deploying generative AI applications, according to an embodiment.

FIG. 5 illustrates a hub-spoke AI agent deployment system for distributed generative AI applications in industrial environments, according to aspects of the present disclosure.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

Prior to a discussion of the preferred embodiment of the invention, it should be understood that the features and advantages of the invention are illustrated in terms of a systems for controlling manufacturing or industrial environments.

The following description sets forth exemplary aspects of the present disclosure. It should be recognized, however, that such description is not intended as a limitation on the scope of the present disclosure. Rather, the description also encompasses combinations and modifications to those exemplary aspects described herein.

The deployment of resource-intensive Generative AI (GenAI) models in industrial manufacturing and factory settings is critically hampered by the physical and infrastructural limitations of these environments. These limitations include insufficient power and cooling capacity for large GPU clusters, high network latency for real-time cloud-based decision-making, and stringent security/data sovereignty requirements that prohibit constant transfer of sensitive operational data to the cloud. The conventional centralized GenAI architecture fails to meet the low-latency, secure, and resilient operational demands of the modern factory floor.

The system of the current disclosure is a scalable Spoke-Hub architecture designed for deploying sophisticated, yet efficient, distributed AI agents. This model strategically allocates computational and reasoning capabilities across the network:
a. Spokes (Edge): Dedicated to high-speed, local decision-making and real-time operational control, utilizing compact, optimized AI models.
b. Hub (Central): Dedicated to complex, generalized reasoning, data aggregation, and centralized model management, utilizing powerful Foundation Models (FMs).

This structure ensures low-latency responses for the majority of tasks at the edge while retaining access to superior, global intelligence for complex problem-solving.

### Spoke-Level Agents and Capabilities (The Edge).

Each Spoke represents an operational endpoint (e.g., a factory floor, a vehicle, or a remote sensor array). The AI agents deployed here are configured for maximum efficiency and local autonomy. The model deployment and optimization include:
a. Smaller/Distilled Models: The AI models deployed at the Spoke are typically smaller, distilled, or quantized versions of larger models. This reduces the computational footprint, enabling deployment on resource-constrained edge hardware. These models are optimized for inference speed in their specific domain.

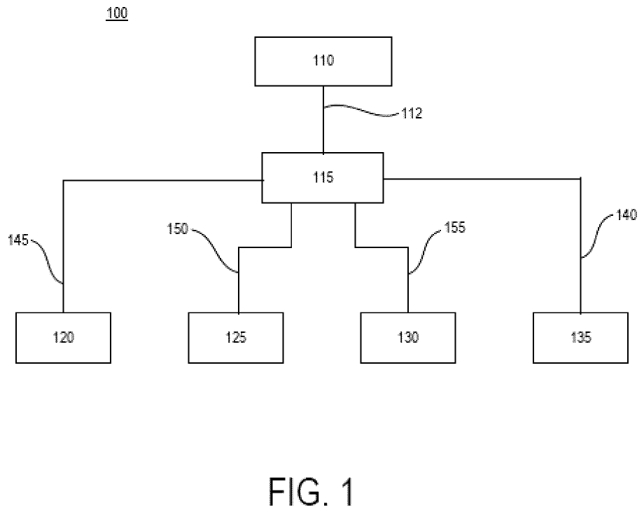

The deployment structure is organized hierarchically, as illustrated in FIG. 1.

### The Role of AI Agents and Data Architecture

A successful distributed GenAI model for industrial use cases hinges on two critical components: a sophisticated Data Architecture and the deployment of intelligent AI Agents.

### The Distributed Data Architecture.

The architecture must support a hybrid data strategy, ensuring low-latency processing at the Edge while utilizing the centralized power of the Hub.

| Component | Location | Role and Function | Data Types Handled |
|---|---|---|---|
| Spoke | Factory/ | Real-time ingestion, pre-processing, | High-volume, high-frequency sensor |
| (Edge) | Local | anonymization, and feature extraction. | data, fault logs, operational telemetry, |
| | Site | Hosts specialized, smaller AI agents and | proprietary manufacturing records. |
| | | purpose built models for immediate, time- | |
| | | sensitive decisions. | |
| | | Ensures site-specific data sovereignty and | |
| | | minimizes latency. | |
| Hub | Central | Hosts fine-tuned | Localized data from Factory floors, |
| | Data | Pharma Foundation Models (FM). | Aggregated sensor data. Insights |
| | Center | Dedicated data aggregation, and | Derived from real-time sensor data. |
| | | centralized inference for non-time-critical | |
| | | queries. | |
| | | Hosts complex suite of Agents for ensuring | |
| | | compliance, Quality assurance. | |
| Cloud | Regional | Hosts the large-scale global Foundation | Global contextual data, historical |
| | Data | Models (FM) fine-tuned for industry specific | benchmarks, model weights, |
| | center | operations. Performs model, fine-tuning, | aggregated and anonymized |
| | | global data aggregation from external sources, | summaries from Spokes. |
| | | research archives. | |

To overcome the Edge environment's computational constraints, the architecture deploys lightweight, specialized AI Agents at the Spoke (factory floor) and industrial IoT devices. This local architecture must also provide the runtime environment for the specialized AI Agents.

The agents perform domain-specific tasks that are too sensitive or high-volume to be handled by the hub or in central cloud:
a. Low-Latency Decision-Making: Agents operate directly on the Edge data to enable real-time control, predictive maintenance alerts, and immediate quality checks, where a delay of milliseconds is unacceptable.
b. Data Curation and Feature Engineering: Agents pre-process raw sensor data, structure unstructured manual records (e.g., maintenance notes), and extract critical features locally, drastically reducing the data volume transmitted to the central Hub.
c. Model Compression and Optimization: Agents utilize compressed or distilled versions of the fine-tuned Pharma Foundation Models, executing inference with minimal computational overhead on available Edge hardware.

The Hub plays a central role in orchestrating the execution of critical, multi-spoke requests. Each Spoke is responsible for executing an agent-chain that encompasses data retrieval, ranking, and evaluation before sending the response back to the Hub for subsequent processing. Furthermore, the Hub utilizes its own agents to grade and evaluate responses received from multiple spokes, ultimately generating a consolidated response for the user's query. See the picture below that shows a functional architecture diagram.

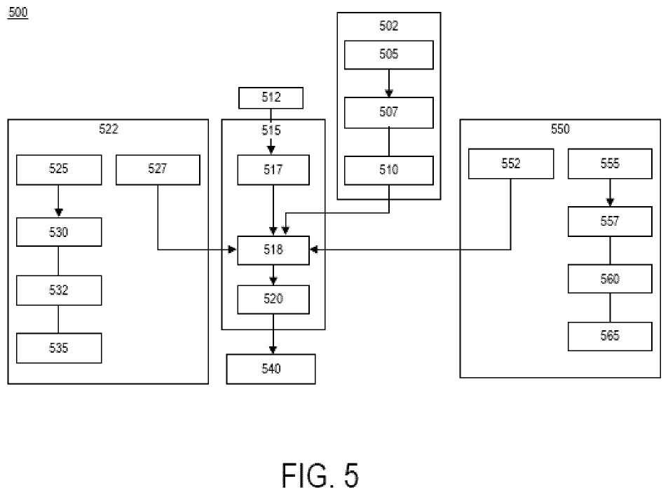

The Spoke architecture is designed for adaptability, with its “personality” and complexity determined by its deployment purpose. This allows the system to scale from Simple Spokes, which are lightweight, dedicated Edge processors focused on real-time validation and timing for short, multi-step machine operations, to Complex Spokes, which monitor multi-day, human-in-the-loop processes (like batch drug production) to ensure end-to-end quality assurance, manage sequencing, and ensure regulatory compliance. This modularity ensures resource efficiency while meeting diverse operational needs, from millisecond-latency control to long-duration compliance tracking. An architecture is shown in the Spoke architecture components section below. The architecture is detailed in the “Spoke architecture components” of FIG. 5.

The industrial use case of a distributed model demands a careful, multi-tenant distributed model deployments designed for resilience and efficiency:
a. Authenticated Private Link: A dedicated, authenticated Private Link must be established between the Edge Agents (Spokes) and the central Foundation Models (Hub) to ensure a secure, high-throughput channel for all inference requests and responses, handling authentication, authorization, and encrypted data transfer.
b. Secure Orchestration: A robust mechanism is required to securely route inference requests between the Edge Agents (Spokes) and the central Foundation Models (Hub).
c. Asynchronous Communication: To account for intermittent or low-bandwidth network conditions at the Edge, the architecture must rely on asynchronous, batch-oriented communication for non-critical data transfer and model updates, ensuring operational continuity even during network outages.

The true power of the Spoke agents lies in their access to curated local tools and data:
a. Real-Time Local Data Access: Agents are configured to use tools that directly interface with the local environment, consuming real-time data such as sensor readings, operational logs, device status, and local historical archives. This ensures immediate, context-aware decision-making.
b. Aggregated Hub Data Consumption: Crucially, once a Spoke is registered and securely connected to the Hub, the deployment pipeline configures tools that can call into the Hub's data services. These tools consume and utilize aggregated and generalized data that the Hub has synthesized from across the entire network (e.g., global performance benchmarks, network-wide anomaly trends, generalized operational insights).

Outcome: The Spoke agents possess a complete, hybrid data view—access to real-time local context and aggregated global context—enabling them to make robust, locally appropriate decisions that benefit from generalized intelligence. 3. Hub-Level Models and Reasoning (The Center).

The Hub functions as the central nervous system, hosting the heavy-lifting computational and analytical resources: A. Complex Reasoning Models
a. The Hub runs more complex and sophisticated reasoning models (often high-parameter Foundation Models) that are too large or computationally intensive to deploy at the edge. These models specialize in generalized problem-solving, deep pattern recognition, and complex data correlation across diverse data streams.
b. These advanced models are made available to all connected Spokes for tasks that require superior analytical depth or a broader contextual understanding.

The architecture facilitates a seamless transition of complexity with distributed model deployments:
a. The Delegation Mechanism: When an AI agent at a Spoke encounters a task that exceeds its local model's reasoning capability (e.g., root-cause analysis involving historical data from multiple sites, or compliance checks against global standards), it initiates a request for assistance.
b. Calling the Hub Model Interface: This task is accomplished by the Spoke agent utilizing a specific tool that calls the Model interface deployed at the Hub.
c. Harnessing Reasoning Power: The Spoke agent sends the relevant local context and the complex query to the Hub. The Hub's powerful models execute the required reasoning, and the resultant insight or action plan is returned to the Spoke.

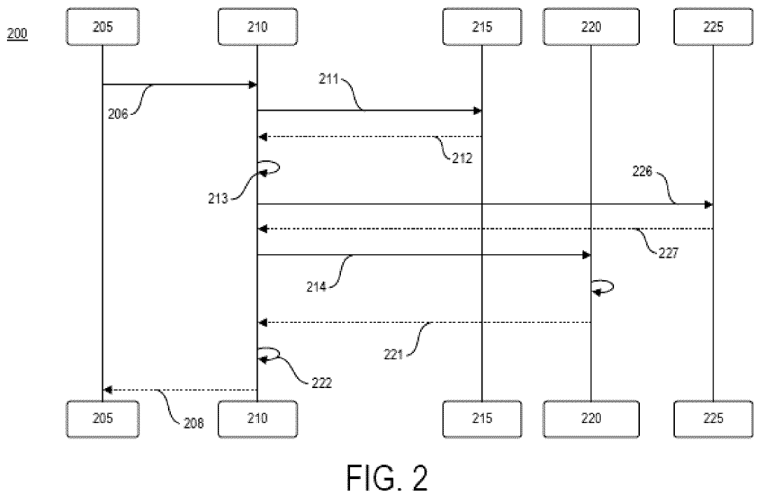

FIG. 2 illustrates the interaction, or handshake, between the AI agents at the Spoke and their connection to the Hub.

The Spoke (Edge) implementation is critical for managing local data streams and providing low-latency GenAI capabilities. Key components include:
a. Local Data Ingestion Layer: Responsible for collecting high-frequency data from diverse local sources, including SCADA systems, industrial controllers (PLCs), sensors, and manually entered production logs.
b. Edge Compute Unit: A specialized, hardened compute appliance designed for industrial environments with TPUs. It hosts the inference engine for the lightweight AI Agents and performs immediate data pre-processing tasks (e.g., time-series aggregation, anomaly detection).
c. Local Contextual Data Store: A local, fast database or time-series database optimized for storing recent, high-volume operational data. This allows agents to perform inference using the most current factory state without requiring constant communication with the Hub.
d. Secure Communication Module: Handles encrypted, authenticated, and potentially asynchronous (store-and-forward) communication with the central Hub. This module ensures data integrity and adherence to multi-tenant isolation protocols.
e. Agent Runtime Environment: A containerized or virtualized environment tailored for running specialized, compressed GenAI models and AI Agents with minimal resource utilization.

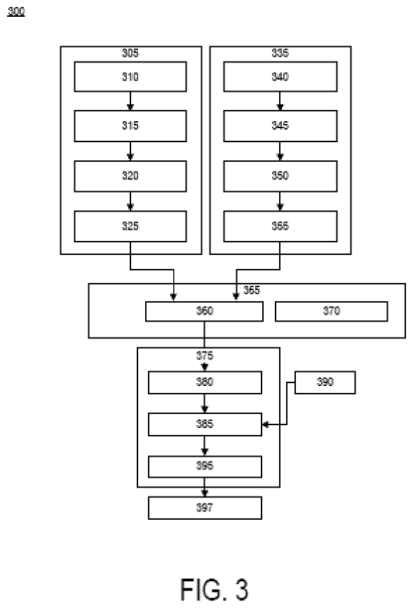

FIG. 3 illustrates the deployment form factors for both Simple and Complex spokes. The specific form factor utilized for a spoke determines the capabilities it can provide.

FIG. 3 illustrates the deployment form factors for both simple and complex spokes. The specific form factor utilized for a spoke determines the capabilities it can provide.

The central Hub serves as the brain of the multi-tenant architecture, managing the high-resource Foundation Models, coordinating multi-site intelligence, and enforcing security and governance.

### 1. Foundation Model (FM) Hosting Layer:

a. Hosts the large-scale, industry-specific Foundation Models (LLMs) that have been fine-tuned on aggregated global and contextual data.
b. Provides the necessary high-capacity GPU/compute infrastructure (e.g., dedicated server clusters with advanced cooling) unsuitable for the Spoke locations.
c. Manages the model lifecycle, including version control, deployment, and performance monitoring

### 2. Global Data Aggregation and Contextualization Layer:

a. Central repository for aggregated, anonymized, and structured data summaries received from all Spokes.
b. Integrates external data sources (e.g., public research, global benchmarks, supply chain data) to enrich the FM's context.
c. Manages a Vector Database for Retrieval-Augmented Generation (RAG) queries, indexing global documents and insights.

### 3. Agent Orchestration and Routing Module:

a. Manages the communication workflow between the end-user/client application and the distributed AI Agents (Spokes).
b. Securely routes user queries to the appropriate Spoke(s) based on tenant ID, data relevance, and required latency.
c. Executes the Hub-level “Meta-Agent” functionality: grading, synthesizing, and consolidating responses received from multiple Spoke Agents before delivering a single, unified answer to the user.

### 4. Multi-Tenant Isolation and Governance Layer:

a. Enforces strict logical and computational separation between data and requests originating from different factory tenants.
b. Manages user authentication (AuthN) and authorization (AuthZ), ensuring users only access results derived from their permitted Spoke data.
c. Provides centralized logging, auditing, and compliance reporting across the entire distributed system.

### 5. Secure Communication Gateway:

a. Terminates the authenticated Private Links from all Spokes.
b. Manages high-throughput, encrypted data flow for inference requests, responses, and batched data transfer for model retraining.
c. Implements rate limiting and traffic management to ensure system stability under high load.

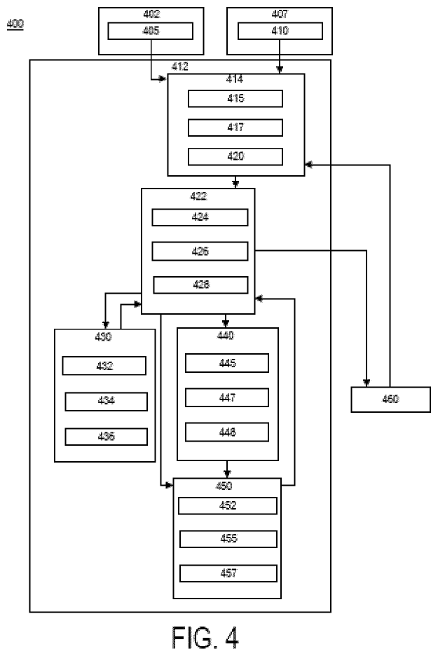

This architecture shown in the figure FIG. 4 features a central processing Hub and distributed Agents located in Spokes. The Spokes connect to the Hub, which is responsible for providing larger context and can also delegate agent tasks back to the Spokes based on the requirements of the query.

Industrial and manufacturing environments present challenges for deploying resource-intensive generative artificial intelligence (GenAI) models. Factory floors and similar operational settings generate continuous, high-volume data from interconnected equipment, devices, and sensors performing diverse operations ranging from precision machining and assembly to quality control and logistics. Data loggers within these environments produce operational data including sensor readings, performance metrics, fault codes, and utilization statistics that are aggregated and managed by data acquisition systems such as SCADA systems serving as central control hubs. In addition to automated data logs, manufacturing environments rely on human-generated data such as manual inspection reports, maintenance journals, operational notes, and shift logs. These unstructured manufacturing records contain context, observations, and expert knowledge that are accurately digitized, captured, and structured for integration into AI model training and inference pipelines.

Industrial sites present infrastructure constraints that limit deployment of large-scale computing resources. Power and cooling limitations exist at industrial sites that lack robust high-capacity electrical infrastructure and dedicated cooling systems to support the power draw of large-scale GPU clusters for GenAI model training and inference. Industrial settings lack dedicated, climate-controlled server rooms, and high levels of dust, temperature fluctuation, and vibration compromise standard data center hardware. Network latency and bandwidth constraints arise when pushing massive amounts of raw, high-frequency data to a central cloud location for immediate processing, introducing latency that is unacceptable for real-time control applications. Intermittent network availability impacts reliance on cloud-only solutions for real-time control applications. Security and data sovereignty requirements lead organizations to keep highly sensitive operational data within local network boundaries through edge computing for security and compliance reasons.

Referring to FIG. 1, a deployment structure 100 addresses these constraints through a distributed, hybrid processing model. The deployment structure 100 includes a cloud provider 110 positioned at a top of a hierarchy. A central hub 115 connects to the cloud provider 110 through a direct connection 112. The central hub 115 serves as a coordination point for the distributed system and hosts foundation models that have been fine-tuned on aggregated global and contextual data for industry-specific operations. The central hub 115 integrates external data sources including public research, global benchmarks, and supply chain data to enrich foundation model context. The central hub 115 provides model lifecycle management including version control, deployment, and performance monitoring of the foundation models. A foundation model hosting layer at the central hub 115 includes dedicated server clusters with advanced cooling unsuitable for spoke locations.

With continued reference to FIG. 1, the central hub 115 connects to multiple spoke nodes arranged in a distributed configuration. These spoke nodes include a first spoke 120, a second spoke 125, a third spoke 130, and a fourth spoke 135. Each spoke represents an operational endpoint such as a factory floor, a vehicle, or a remote sensor array within an industrial environment. The connections between the central hub 115 and the various spokes are established through different types of private links that handle data transfer functions. A private link 140 connects to the fourth spoke 135 and transfers agent-to-model, agent-to-agent, and model-to-tool data. An agent-to-model private link 145 connects the central hub 115 to the first spoke 120 and transfers agent-to-model data. An agent-to-agent private link 150 connects the central hub 115 to the second spoke 125 and handles agent-to-agent data transfer. A model-to-tool private link 155 connects the central hub 115 to the third spoke 130 and transfers model-to-tool data.

Referring to FIG. 5, a hub-spoke AI agent deployment system 500 illustrates the distribution of AI agents across the architecture. The hub-spoke AI agent deployment system 500 comprises a central hub cloud 515 that coordinates operations between multiple spoke modules deployed at edge locations. The central hub cloud 515 includes an agent discovery service module 517 that receives a user query 512. The agent discovery service module 517 connects to a hub agent orchestration module 518 that performs orchestration and grading functions. The hub agent orchestration module 518 passes processed data to a consolidated response generator 520, which produces a consolidated response output 540 delivered to a user. The hub agent orchestration module 518 runs more complex and sophisticated reasoning models with high-parameter foundation models that specialize in generalized problem-solving, deep pattern recognition, and complex data correlation across diverse data streams.

With continued reference to FIG. 5, an additional edge spoke module 502 comprises a factory systems module 505 that interfaces with sensors, PLCs, and machines. The additional edge spoke module 502 includes a specialized agents module 507 configured for domain-specific tasks and an agent chain module 510 that performs retrieval, ranking, and evaluation operations. The agent chain module 510 transmits data to the hub agent orchestration module 518. A factory floor spoke module 522 is configured with factory systems 525 that connect to sensors, PLCs, and machines. The factory floor spoke module 522 includes an agent chain 527 that performs retrieval, ranking, and evaluation, passing data to the hub agent orchestration module 518. The factory systems 525 connect to a low-latency decision-making agent 530, which passes data to a data curation agent 532 for data curation and feature engineering operations. The data curation agent 532 connects to a model compression agent 535 that handles model compression and optimization.

As further shown in FIG. 5, an IoT devices spoke module 550 includes a retrieval agent chain 552 that performs retrieval, ranking, and evaluation, transmitting data to the hub agent orchestration module 518. The IoT devices spoke module 550 contains a factory systems component 555 that connects to a low-latency decision agent 557, a feature engineering agent 560 for data curation and feature engineering, and an optimization agent 565 for model compression and optimization. The spoke agents perform data curation tasks including pre-processing raw sensor data, structuring unstructured manual records such as maintenance notes, and extracting features locally to reduce data volume transmitted to the hub. The spoke agents access tools that call into hub data services to consume and utilize aggregated and generalized data synthesized from across the entire network including global performance benchmarks, network-wide anomaly trends, and generalized operational insights.

Referring to FIG. 2, a sequence diagram 200 represents the interaction between AI agents at a spoke and their connection to a hub. The sequence diagram 200 includes a user 205, a spoke agent 210, local tools and data 215, hub complex models 220, and hub data services 225. A task submission step 206 initiates when the user 205 submits a task containing both simple and complex components to the spoke agent 210. The spoke agent 210 initiates a data access step 211 to access real-time sensor data, logs, and device status from the local tools and data 215. A local context return step 212 returns the local context to the spoke agent 210. The spoke agent 210 performs a local task execution step 213 to execute simple tasks locally, including low-latency decisions and validation operations.

With continued reference to FIG. 2, a global context request step 226 requests aggregated and global context information such as benchmarks and anomaly trends from the hub data services 225. A generalized insights return step 227 provides the requested generalized insights back to the spoke agent 210. A complex task delegation step 214 delegates tasks such as root-cause analysis and compliance checks to the hub complex models 220 when a task exceeds local reasoning capability. A delegation mechanism allows the spoke agent 210 to initiate a request for assistance when encountering a task that exceeds local model reasoning capability such as root-cause analysis involving historical data from multiple sites or compliance checks against global standards. A complex reasoning results return step 221 returns the complex reasoning results to the spoke agent 210. A context fusion step 222 fuses the local and global context together. A consolidated response delivery step 208 delivers a consolidated response to the user 205.

Referring to FIG. 3, deployment form factors 300 illustrate configurations for spoke implementations. A simple edge spoke 305 represents a lightweight edge processor configuration focused on real-time validation and timing for short, multi-step machine operations. The simple edge spoke 305 includes connectors 310 for sensor and IoT data streams, which feed data to a distilled focused AI model 315.

The distilled focused AI model 315 passes processed data to AI agents 320 configured for real-time validation and timing operations. The AI agents 320 store data in local data storage 325, which functions as a site data-fabric node. The AI models deployed at the spoke are smaller, distilled, or quantized versions of larger models to reduce the computational footprint and enable deployment on resource-constrained edge hardware.

With continued reference to FIG. 3, a complex edge spoke 335 represents a more sophisticated edge processor configuration that monitors multi-day, human-in-the-loop processes like batch drug production to ensure end-to-end quality assurance, manage sequencing, and ensure regulatory compliance. The complex edge spoke 335 includes connectors 340 for sensor and IoT data streams, which feed data to a distilled focused AI model 345. The distilled focused AI model 345 passes processed data to AI agents 350 configured for quality assurance, sequencing, and compliance tracking operations. The AI agents 350 store data in local data storage 355, which also functions as a site data-fabric node.

As further shown in FIG. 3, both local data storage 325 and local data storage 355 connect to a site-wide data fabric 365. The site-wide data fabric 365 comprises a distributed storage layer 360 and metadata and compliance services 370. The distributed storage layer 360 aggregates data from both spoke configurations and provides unified data access across the site. The distributed storage layer 360 connects to a central hub 375 through PrivateLink connectivity 380. The central hub 375 operates in a cloud environment and includes an agent discovery and orchestration service 385. The agent discovery and orchestration service 385 receives a user query 390 and coordinates processing across the distributed system. The agent discovery and orchestration service 385 passes requests to hub agents 395, which perform grading and consolidation functions. The hub agents 395 generate a consolidated response 397 delivered to the user.

Referring to FIG. 4, a hub and spoke architecture 400 illustrates the multi-tenant architecture components. A first spoke edge site 402 contains local inference AI agents 405 configured to perform local inference and validation tasks. A second spoke edge site 407 contains compliance AI agents 410 configured to handle compliance, sequencing, and quality assurance operations. A central hub 412 serves as the brain of the multi-tenant architecture and comprises multiple interconnected layers and modules. A secure communication gateway 414 manages communications between the spokes and the hub. The secure communication gateway 414 includes a private link termination module 415 for terminating authenticated private links from the spokes, an encrypted data flow module 417 for managing high throughput encrypted data transfer, and a rate limiting module 420 for traffic management and system stability. The secure communication gateway 414 implements rate limiting and traffic management to ensure system stability under high load.

With continued reference to FIG. 4, an agent orchestration module 422 handles the routing and coordination of queries and responses. The agent orchestration module 422 includes a secure query routing module 424 that routes queries based on tenant ID, latency, and relevance. A meta-agent grading module 426 grades and synthesizes responses received from multiple spoke agents. A unified answer consolidation module 428 consolidates the graded responses into a single unified answer. The agent orchestration module 422 routes user queries to appropriate spokes based on tenant ID, data relevance, and required latency.

As further shown in FIG. 4, a multi-tenant isolation layer 430 enforces separation between different factory tenants. The multi-tenant isolation layer 430 includes a logical separation module 432 for logical and computational separation, an authentication enforcement module 434 for managing authentication and authorization, and a centralized logging module 436 for logging, auditing, and compliance reporting. A global data aggregation layer 440 manages aggregated data from the spokes and external sources. The global data aggregation layer 440 includes an aggregated data summaries module 445 for storing summaries from spokes, an external data sources module 447 for integrating research, benchmarks, and supply chain data, and a vector database module 448 for retrieval-augmented generation queries.

With continued reference to FIG. 4, a foundation model hosting layer 450 hosts the large-scale AI models. The foundation model hosting layer 450 includes a foundation models module 452 containing industry-specific foundation models, a GPU compute infrastructure 455 providing high-capacity computational resources, and a model lifecycle management module 457 for versioning, deployment, and monitoring. An end-user client application 460 connects to the central hub 412 for submitting queries and receiving consolidated responses. The local inference AI agents 405 and compliance AI agents 410 connect to the secure communication gateway 414. The secure communication gateway 414 connects to the agent orchestration module 422. The agent orchestration module 422 connects to the multi-tenant isolation layer 430, the global data aggregation layer 440, and the foundation model hosting layer 450.

The spoke architecture includes an edge computing unit implemented as a specialized, hardened computing appliance designed for industrial environments with TPUs for hosting an inference engine. A local contextual data store at the spoke is implemented as a fast database or time-series database optimized for storing recent, high-volume operational data. An agent runtime environment at the spoke is implemented as a containerized or virtualized environment tailored for running specialized, compressed GenAI models and AI agents with minimal resource utilization. A local data ingestion layer at the spoke collects high-frequency data from diverse local sources including SCADA systems, industrial controllers (PLCs), sensors, and manually entered production logs. A secure communication module at the spoke handles encrypted, authenticated, and asynchronous store-and-forward communication with the central hub. The spoke agents perform immediate data pre-processing tasks including time-series aggregation and anomaly detection on the edge compute unit. A cloud layer hosts large-scale global foundation models fine-tuned for industry-specific operations and performs model fine-tuning and global data aggregation from external sources and research archives.

Referring to FIG. 1, the deployment structure 100 implements a star topology configuration where the central hub 115 functions as a coordination point connecting to each spoke node. The cloud provider 110 is positioned at a top of the hierarchy and connects to the central hub 115 through the direct connection 112. The central hub 115 hosts foundation models and high-capacity GPU computing infrastructure that industrial sites lack the power and cooling capacity to support. Industrial sites lack robust high-capacity electrical infrastructure and dedicated cooling systems to support large-scale GPU clusters for GenAI model training and inference. The central hub 115 provides the computational resources for complex reasoning tasks while the spoke nodes handle local processing at edge locations.

With continued reference to FIG. 1, the first spoke 120, the second spoke 125, the third spoke 130, and the fourth spoke 135 are arranged in a distributed configuration around the central hub 115. Each spoke represents an operational endpoint within an industrial environment. The first spoke 120 is configured as a factory floor endpoint that interfaces with manufacturing equipment and sensors. The second spoke 125 is configured as a vehicle endpoint that processes data from mobile industrial assets. The third spoke 130 is configured as a remote sensor array endpoint that aggregates data from distributed monitoring equipment. The fourth spoke 135 is configured as a combined operational endpoint that handles multiple data types from diverse industrial sources.

As further shown in FIG. 1, the connections between the central hub 115 and the various spokes are established through differentiated private links that handle specific data transfer functions. The agent-to-model private link 145 connects the central hub 115 to the first spoke 120 and transfers agent-to-model data, enabling AI agents at the first spoke 120 to communicate with foundation models hosted at the central hub 115 for complex inference requests. The agent-to-agent private link 150 connects the central hub 115 to the second spoke 125 and handles agent-to-agent data transfer, enabling coordination between distributed AI agents across the architecture. The model-to-tool private link 155 connects the central hub 115 to the third spoke 130 and transfers model-to-tool data, enabling foundation models to interface with local tools and data sources at the spoke.

With continued reference to FIG. 1, the private link 140 connects to the fourth spoke 135 and transfers agent-to-model, agent-to-agent, and model-to-tool data through a single authenticated channel. The private link 140 provides a comprehensive communication pathway that supports all interaction types between the fourth spoke 135 and the central hub 115. Each private link implements encrypted, authenticated data transfer to maintain security across the distributed system.

The deployment structure 100 addresses network latency and bandwidth constraints inherent in industrial environments. Pushing massive amounts of raw high-frequency data to a central cloud location introduces latency that is unacceptable for real-time control applications. The spoke nodes perform local processing and feature extraction to reduce data volume transmitted to the central hub 115. The differentiated private links enable selective data routing based on the type of interaction, allowing time-sensitive operations to be handled locally while complex reasoning tasks are delegated to the central hub 115.

The deployment structure 100 supports data sovereignty at local network boundaries through edge computing at each spoke. The first spoke 120, the second spoke 125, the third spoke 130, and the fourth spoke 135 each maintain local data storage and processing capabilities that keep highly sensitive operational data within local network boundaries. This configuration addresses security and compliance requirements that lead organizations to retain proprietary manufacturing data at edge locations rather than transmitting raw data to centralized cloud infrastructure.

Referring to FIG. 2, the sequence diagram 200 illustrates the interaction workflow between the user 205, the spoke agent 210, the local tools and data 215, the hub complex models 220, and the hub data services 225. The sequence diagram 200 depicts a hybrid processing model where the spoke agent 210 handles time-sensitive operations locally while delegating complex reasoning tasks to the hub complex models 220.

The task submission step 206 initiates the workflow when the user 205 submits a task containing both simple and complex components to the spoke agent 210. The spoke agent 210 receives the submitted task and determines which components are processed locally and which components require delegation to the hub complex models 220. Following the task submission step 206, the spoke agent 210 performs the data access step 211 to retrieve real-time sensor data, operational logs, and device status information from the local tools and data 215. The local tools and data 215 provides direct access to the local environment including sensor readings, operational logs, device status, and local historical archives.

With continued reference to FIG. 2, the local context return step 212 returns the retrieved local context from the local tools and data 215 to the spoke agent 210. The spoke agent 210 receives the local context and proceeds to execute the local task execution step 213 for simple task components. During the local task execution step 213, the spoke agent 210 executes low-latency decisions and validation operations directly on the edge data. The local task execution step 213 enables real-time control, predictive maintenance alerts, and immediate quality checks where delays of milliseconds are unacceptable for operational control.

The spoke agent 210 accesses the hub data services 225 through the global context request step 226 to obtain aggregated global context information. The global context request step 226 requests benchmarks, anomaly trends, and other generalized data that the hub data services 225 has synthesized from across the entire network. The hub data services 225 stores global performance benchmarks, network-wide anomaly trends, and generalized operational insights aggregated from all connected spokes. The generalized insights return step 227 provides the requested generalized insights back to the spoke agent 210, enabling the spoke agent 210 to incorporate network-wide context into local decision-making processes.

As further shown in FIG. 2, the complex task delegation step 214 occurs when the spoke agent 210 encounters a task that exceeds local model reasoning capability. A delegation mechanism allows the spoke agent 210 to initiate a request for assistance when encountering tasks such as root-cause analysis involving historical data from multiple sites or compliance checks against global standards. The spoke agent 210 sends relevant local context and the complex query to the hub complex models 220 through the complex task delegation step 214. The hub complex models 220 runs more complex and sophisticated reasoning models with high-parameter foundation models that specialize in generalized problem-solving, deep pattern recognition, and complex data correlation across diverse data streams.

With continued reference to FIG. 2, the hub complex models 220 executes the delegated task using high-parameter foundation models and returns results through the complex reasoning results return step 221. The complex reasoning results return step 221 transmits the complex reasoning results back to the spoke agent 210. The spoke agent 210 receives both the local context from the local tools and data 215 and the complex reasoning results from the hub complex models 220.

The context fusion step 222 fuses the local context and the global context together at the spoke agent 210. During the context fusion step 222, the spoke agent 210 combines real-time local context with aggregated global context and complex reasoning results to generate a comprehensive response. The spoke agent 210 possesses a complete hybrid data view through access to real-time local context and aggregated global context, enabling robust locally appropriate decisions that benefit from generalized intelligence. The consolidated response delivery step 208 delivers the consolidated response from the spoke agent 210 to the user 205, completing the interaction workflow depicted in the sequence diagram 200.

Referring to FIG. 3, the deployment form factors 300 illustrate two spoke configurations that address different operational requirements within industrial environments. The simple edge spoke 305 is configured as a lightweight, dedicated edge processor focused on real-time validation and timing for short, multi-step machine operations. The complex edge spoke 335 is configured to monitor multi-day, human-in-the-loop processes such as batch drug production to ensure end-to-end quality assurance, manage sequencing, and ensure regulatory compliance. This modularity ensures resource efficiency while meeting diverse operational needs ranging from millisecond-latency control to long-duration compliance tracking.

With continued reference to FIG. 3, the simple edge spoke 305 includes the connectors 310 that interface with sensor and IoT data streams from industrial equipment. The connectors 310 collect high-frequency data from diverse local sources including SCADA systems, industrial controllers, sensors, and manually entered production logs. The connectors 310 feed data to the distilled focused AI model 315, which is implemented as a compressed, distilled, or quantized version of a larger foundation model. The distilled focused AI model 315 reduces the computational footprint and enables deployment on resource-constrained edge hardware while maintaining inference speed for domain-specific operations.

The distilled focused AI model 315 passes processed data to the AI agents 320, which are configured for real-time validation and timing operations. The AI agents 320 perform low-latency decision-making directly on edge data for time-sensitive functions where delays of milliseconds are unacceptable for operational control. The AI agents 320 store data in the local data storage 325, which functions as a site data-fabric node. The local data storage 325 is implemented as a time-series database optimized for storing recent, high-volume operational data, enabling the AI agents 320 to perform inference using the most current factory state without requiring constant communication with the central hub 375.

As further shown in FIG. 3, the complex edge spoke 335 includes the connectors 340 that interface with sensor and IoT data streams. The connectors 340 collect data from industrial equipment and feed the data to the distilled focused AI model 345. The distilled focused AI model 345 is implemented as a compressed, distilled, or quantized version of a larger foundation model, similar to the distilled focused AI model 315 but configured for more sophisticated processing requirements. The distilled focused AI model 345 passes processed data to the AI agents 350, which are configured for quality assurance, sequencing, and compliance tracking operations.

With continued reference to FIG. 3, the AI agents 350 monitor multi-day processes and ensure end-to-end quality assurance throughout batch production operations. The AI agents 350 manage sequencing of production steps and track regulatory compliance requirements. The AI agents 350 store data in the local data storage 355, which also functions as a site data-fabric node. The local data storage 355 is implemented as a time-series database optimized for storing recent, high-volume operational data, enabling the AI agents 350 to access historical context for compliance verification and quality assurance decisions.

Both the local data storage 325 and the local data storage 355 connect to the site-wide data fabric 365. The site-wide data fabric 365 comprises the distributed storage layer 360 and the metadata and compliance services 370. The distributed storage layer 360 aggregates data from both the simple edge spoke 305 and the complex edge spoke 335, providing unified data access across the site. The metadata and compliance services 370 manage metadata indexing and compliance tracking across the distributed storage infrastructure.

As further shown in FIG. 3, the distributed storage layer 360 connects to the central hub 375 through the PrivateLink connectivity 380. The PrivateLink connectivity 380 establishes a dedicated, authenticated connection that ensures secure, high-throughput, encrypted data transfer for inference requests and responses between the spoke configurations and the central hub 375. The central hub 375 operates in a cloud environment and includes the agent discovery and orchestration service 385.

With continued reference to FIG. 3, the agent discovery and orchestration service 385 receives the user query 390 and coordinates processing across the distributed system. The agent discovery and orchestration service 385 routes the user query 390 to appropriate spoke configurations based on tenant identification, data relevance, and latency requirements. The agent discovery and orchestration service 385 passes requests to the hub agents 395, which perform grading and consolidation functions on responses received from the simple edge spoke 305 and the complex edge spoke 335. The hub agents 395 generate the consolidated response 397 that is delivered to the user.

The simple edge spoke 305 and the complex edge spoke 335 each include an edge compute unit implemented as a specialized, hardened compute appliance designed for industrial environments. The edge compute unit includes TPUs for hosting an inference engine that executes the distilled focused AI model 315 or the distilled focused AI model 345. The hardened compute appliance is designed to withstand high levels of dust, temperature fluctuation, and vibration that characterize industrial settings and compromise standard data center hardware.

The simple edge spoke 305 and the complex edge spoke 335 each include an agent runtime environment implemented as a containerized environment tailored for running specialized, compressed GenAI models and AI agents with minimal resource utilization. The containerized environment provides isolation between different AI agents and enables deployment of the AI agents 320 and the AI agents 350 on the edge compute unit. The containerized environment supports the execution of agent chains that encompass data retrieval, ranking, and evaluation before sending responses to the hub agents 395 for subsequent processing.

Referring to FIG. 4, the hub and spoke architecture 400 illustrates the central hub architecture components and their interconnections with distributed spoke edge sites. The first spoke edge site 402 contains the local inference AI agents 405 that perform local inference and validation tasks at an edge location. The second spoke edge site 407 contains the compliance AI agents 410 that handle compliance, sequencing, and quality assurance operations at a separate edge location. The local inference AI agents 405 and the compliance AI agents 410 connect to the central hub 412 through authenticated private links that terminate at the secure communication gateway 414.

With continued reference to FIG. 4, the central hub 412 functions as the coordination center for the multi-tenant architecture and comprises multiple interconnected layers and modules. The secure communication gateway 414 manages all communications between the spoke edge sites and the central hub 412. The secure communication gateway 414 includes the private link termination module 415 that terminates authenticated private links from the first spoke edge site 402 and the second spoke edge site 407. The private link termination module 415 establishes secure endpoints for each authenticated connection from distributed spoke locations.

The secure communication gateway 414 includes the encrypted data flow module 417 that manages high throughput encrypted data transfer between the spoke edge sites and the central hub 412. The encrypted data flow module 417 handles encryption and decryption of inference requests, responses, and batched data transfers for model retraining. The encrypted data flow module 417 supports asynchronous store-and-forward communication that buffers non-time-critical data transfer during network outages, enabling operational continuity when intermittent network availability or low-bandwidth conditions exist between spoke locations and the central hub 412.

As further shown in FIG. 4, the secure communication gateway 414 includes the rate limiting module 420 that implements rate limiting and traffic management to ensure system stability under high load conditions. The rate limiting module 420 controls the flow of inference requests and data transfers to prevent system overload when multiple spoke edge sites submit concurrent requests. The rate limiting module 420 manages traffic prioritization to ensure time-sensitive requests receive appropriate processing priority.

With continued reference to FIG. 4, the agent orchestration module 422 handles the routing and coordination of queries and responses within the central hub 412. The agent orchestration module 422 includes the secure query routing module 424 that routes user queries to appropriate spoke edge sites based on tenant identification, data relevance, and required latency. The secure query routing module 424 implements multi-factor query routing that evaluates tenant identification to ensure proper data isolation, assesses data relevance to determine which spoke locations contain pertinent information, and considers latency requirements to meet response time constraints.

The agent orchestration module 422 includes the meta-agent grading module 426 that grades and synthesizes responses received from multiple spoke agents including the local inference AI agents 405 and the compliance AI agents 410. The meta-agent grading module 426 evaluates response quality, relevance, and completeness from each spoke edge site. The agent orchestration module 422 includes the unified answer consolidation module 428 that consolidates the graded responses into a single unified answer for delivery to users. The unified answer consolidation module 428 combines insights from multiple spoke locations into a coherent response that incorporates both local context and global intelligence.

As further shown in FIG. 4, the multi-tenant isolation layer 430 enforces separation between different factory tenants throughout the central hub 412. The multi-tenant isolation layer 430 includes the logical separation module 432 that maintains logical and computational separation of data and requests originating from different factory tenants. The logical separation module 432 ensures that data from one tenant remains isolated from data belonging to other tenants during processing and storage operations.

With continued reference to FIG. 4, the multi-tenant isolation layer 430 includes the authentication enforcement module 434 that manages user authentication and authorization. The authentication enforcement module 434 ensures users access GenAI results derived from their permitted spoke data and prevents unauthorized access to data from other tenants. The multi-tenant isolation layer 430 includes the centralized logging module 436 that provides logging, auditing, and compliance reporting across all connected spoke edge sites. The centralized logging module 436 maintains audit trails for regulatory compliance and security monitoring purposes.

The global data aggregation layer 440 manages aggregated data from the spoke edge sites and external sources. The global data aggregation layer 440 includes the aggregated data summaries module 445 that stores aggregated, anonymized, and structured data summaries received from the first spoke edge site 402, the second spoke edge site 407, and other connected spoke locations. The aggregated data summaries module 445 maintains historical data that supports complex reasoning tasks performed by foundation models.

As further shown in FIG. 4, the global data aggregation layer 440 includes the external data sources module 447 that integrates external data sources including public research, global benchmarks, and supply chain data to enrich foundation model context. The external data sources module 447 aggregates data from sources outside the spoke network to provide broader contextual information for inference operations. The global data aggregation layer 440 includes the vector database module 448 that supports retrieval-augmented generation queries. The vector database module 448 indexes global documents and insights to enable semantic search and context retrieval during inference operations.

With continued reference to FIG. 4, the foundation model hosting layer 450 hosts large-scale AI models that perform complex reasoning tasks. The foundation model hosting layer 450 includes the foundation models module 452 containing industry-specific foundation models that have been fine-tuned on aggregated global and contextual data for industry-specific operations. The foundation models module 452 stores high-parameter foundation models that specialize in generalized problem-solving, deep pattern recognition, and complex data correlation across diverse data streams.

The foundation model hosting layer 450 includes the GPU compute infrastructure 455 that provides high-capacity computational resources for foundation model inference and training. The GPU compute infrastructure 455 comprises dedicated server clusters with advanced cooling systems that are unsuitable for deployment at spoke locations due to power and cooling limitations at industrial sites. The GPU computing infrastructure 455 provides the computational capacity for running complex reasoning models that exceed the processing capabilities of edge hardware at spoke locations.

As further shown in FIG. 4, the foundation model hosting layer 450 includes the model lifecycle management module 457 that provides version control, deployment, and performance monitoring of the foundation models. The model lifecycle management module 457 manages model versioning to track changes and updates to foundation models over time. The model lifecycle management module 457 handles deployment of updated models to the foundation models module 452 and monitors model performance to ensure inference quality and efficiency.

With continued reference to FIG. 4, the end-user client application 460 connects to the central hub 412 for submitting queries and receiving consolidated responses. The end-user client application 460 transmits user queries to the secure communication gateway 414, which routes the queries through the agent orchestration module 422 for processing. The agent orchestration module 422 coordinates with the multi-tenant isolation layer 430 to verify user authorization, accesses the global data aggregation layer 440 for contextual data, and utilizes the foundation model hosting layer 450 for complex reasoning operations. The unified answer consolidation module 428 generates consolidated responses that are transmitted back to the end-user client application 460 through the secure communication gateway 414.

Referring to FIG. 5, the hub-spoke AI agent deployment system 500 implements a data fabric architecture that coordinates multi-source data ingestion and processing across distributed industrial environments. The central hub cloud 515 receives the user query 512 at the agent discovery service module 517. The agent discovery service module 517 identifies appropriate spoke modules for processing the user query 512 based on data location, tenant identification, and processing requirements. The agent discovery service module 517 routes requests to the hub agent orchestration module 518, which coordinates execution across the distributed spoke modules and performs grading functions on responses received from multiple sources.

With continued reference to FIG. 5, the hub agent orchestration module 518 receives processed data from the agent chain module 510, the agent chain 527, and the retrieval agent chain 552. The hub agent orchestration module 518 evaluates and grades responses from each spoke module to assess quality, relevance, and completeness. The hub agent orchestration module 518 passes graded responses to the consolidated response generator 520. The consolidated response generator 520 synthesizes responses from multiple spoke modules into a unified output. The consolidated response generator 520 produces the consolidated response output 540 that is delivered to the user who submitted the user query 512.

As shown in FIG. 5, the additional edge spoke module 502 interfaces with industrial equipment through the factory systems module 505. The factory systems module 505 connects to sensors, programmable logic controllers (PLCs), and machines deployed on factory floors. The factory systems module 505 collects high-frequency data from SCADA systems that serve as central control hubs for monitoring and managing production processes. The factory systems module 505 ingests operational data including sensor readings, performance metrics, fault codes, and utilization statistics from data loggers within the industrial environment.

With continued reference to FIG. 5, the specialized agents module 507 within the additional edge spoke module 502 executes domain-specific tasks tailored to the operational requirements of the connected factory systems. The specialized agents module 507 performs data curation tasks including pre-processing raw sensor data received from the factory systems module 505. The specialized agents module 507 structures unstructured manual records such as maintenance notes and operational journals into formats suitable for AI model inference. The specialized agents module 507 extracts features locally from the ingested data to reduce data volume transmitted to the central hub cloud 515.

The agent chain module 510 within the additional edge spoke module 502 performs retrieval, ranking, and evaluation operations on data processed by the specialized agents module 507. The agent chain module 510 retrieves relevant data from local storage based on query requirements. The agent chain module 510 ranks retrieved data according to relevance and quality metrics. The agent chain module 510 evaluates the ranked data and transmits processed responses to the hub agent orchestration module 518 for grading and consolidation.

As further shown in FIG. 5, the factory floor spoke module 522 is configured with the factory systems 525 that connect to sensors, PLCs, and machines deployed in manufacturing environments. The factory systems 525 collects high-frequency data from diverse local sources including SCADA systems and industrial controllers. The factory systems 525 ingests manually entered production logs that contain operational context and expert knowledge from human operators. Human-generated data such as manual inspection reports, maintenance journals, operational notes, and shift logs are accurately digitized, captured, and structured for integration into AI model training and inference pipelines through the factory floor spoke module 522.

With continued reference to FIG. 5, the factory systems 525 connects to the low-latency decision-making agent 530, which performs immediate data pre-processing tasks on incoming sensor streams. The low-latency decision-making agent 530 executes time-series aggregation on high-frequency sensor data to reduce data volume while preserving operational context. The low-latency decision-making agent 530 performs anomaly detection on the edge compute unit to identify deviations from expected operational patterns. The low-latency decision-making agent 530 generates real-time alerts for predictive maintenance and quality control applications where processing delays are unacceptable.

The low-latency decision-making agent 530 passes processed data to the data curation agent 532. The data curation agent 532 performs data curation tasks including pre-processing raw sensor data and structuring unstructured manual records. The data curation agent 532 digitizes handwritten or manually entered records from maintenance journals and shift logs. The data curation agent 532 extracts features from the curated data to prepare inputs for AI model inference operations. The data curation agent 532 connects to the model compression agent 535, which handles model compression and optimization operations.

As further shown in FIG. 5, the model compression agent 535 manages compressed, distilled, or quantized versions of foundation models deployed at the factory floor spoke module 522. The model compression agent 535 optimizes model execution for resource-constrained edge hardware with limited power and cooling capacity. The model compression agent 535 reduces computational footprint while maintaining inference accuracy for domain-specific operations. The agent chain 527 within the factory floor spoke module 522 performs retrieval, ranking, and evaluation on data processed through the low-latency decision-making agent 530, the data curation agent 532, and the model compression agent 535. The agent chain 527 transmits evaluated responses to the hub agent orchestration module 518.

With continued reference to FIG. 5, the IoT devices spoke module 550 contains the factory systems component 555 that interfaces with distributed sensor networks and IoT devices across industrial facilities. The factory systems component 555 collects high-frequency data from sensors, PLCs, and monitoring equipment deployed throughout the operational environment. The factory systems component 555 ingests data from SCADA systems and industrial controllers that manage production processes.

The factory systems component 555 connects to the low-latency decision agent 557, which performs immediate data pre-processing tasks including time-series aggregation and anomaly detection. The low-latency decision agent 557 processes incoming sensor streams to identify operational anomalies and generate real-time alerts. The factory systems component 555 also connects to the feature engineering agent 560, which performs data curation and feature extraction operations. The feature engineering agent 560 pre-processes raw sensor data and structures unstructured manual records for AI model inference. The feature engineering agent 560 extracts features locally to reduce data volume transmitted to the central hub cloud 515.

As further shown in FIG. 5, the factory systems component 555 connects to the optimization agent 565, which handles model compression and optimization for edge deployment. The optimization agent 565 manages compressed model versions that execute on resource-constrained edge hardware within the IoT devices spoke module 550. The retrieval agent chain 552 within the IoT devices spoke module 550 performs retrieval, ranking, and evaluation operations on data processed by the low-latency decision agent 557, the feature engineering agent 560, and the optimization agent 565. The retrieval agent chain 552 transmits evaluated responses to the hub agent orchestration module 518 for grading and consolidation with responses from the additional edge spoke module 502 and the factory floor spoke module 522.

The central hub cloud 515 hosts large-scale global foundation models fine-tuned for industry-specific operations. The central hub cloud 515 performs model fine-tuning using aggregated data received from the additional edge spoke module 502, the factory floor spoke module 522, and the IoT devices spoke module 550. The central hub cloud 515 performs global data aggregation from external sources and research archives to enrich foundation model context. The hub agent orchestration module 518 coordinates inference operations between the spoke modules and the foundation models hosted at the central hub cloud 515, enabling complex reasoning tasks that exceed the processing capabilities of edge hardware at spoke locations.

FIG. 1 illustrates the deployment structure 100 comprising the cloud provider 110, the direct connection 112, the central hub 115, the first spoke 120, the second spoke 125, the third spoke 130, the fourth spoke 135, the private link 140, the agent-to-model private link 145, the agent-to-agent private link 150, and the model-to-tool private link 155. The deployment structure 100 implements a star topology configuration where the central hub 115 functions as a coordination point connecting to each spoke node. The cloud provider 110 is positioned at a top of the hierarchy and connects to the central hub 115 through the direct connection 112. The first spoke 120 connects to the central hub 115 through the agent-to-model private link 145 that transfers agent-to-model data. The second spoke 125 connects to the central hub 115 through the agent-to-agent private link 150 that handles agent-to-agent data transfer. The third spoke 130 connects to the central hub 115 through the model-to-tool private link 155 that transfers model-to-tool data. The fourth spoke 135 connects to the central hub 115 through the private link 140 that transfers agent-to-model, agent-to-agent, and model-to-tool data. Each spoke represents an operational endpoint including a factory floor, a vehicle, or a remote sensor array within an industrial environment. The central hub 115 hosts foundation models that have been fine-tuned on aggregated global and contextual data for industry-specific operations. The central hub 115 integrates external data sources including public research, global benchmarks, and supply chain data to enrich foundation model context. The system addresses power and cooling limitations at industrial sites that lack robust high-capacity electrical infrastructure and dedicated cooling systems to support large-scale GPU clusters.

FIG. 2 illustrates the sequence diagram 200 comprising the user 205, the task submission step 206, the consolidated response delivery step 208, the spoke agent 210, the data access step 211, the local context return step 212, the local task execution step 213, the complex task delegation step 214, the local tools and data 215, the hub complex models 220, the complex reasoning results return step 221, the context fusion step 222, the hub data services 225, the global context request step 226, and the generalized insights return step 227. The user 205 submits a task through the task submission step 206 to the spoke agent 210. The spoke agent 210 performs the data access step 211 to access real-time sensor data, logs, and device status from the local tools and data 215. The local tools and data 215 returns local context through the local context return step 212 to the spoke agent 210. The spoke agent 210 executes the local task execution step 213 for low-latency decisions and validation operations. The spoke agent 210 performs the global context request step 226 to request aggregated global context from the hub data services 225. The hub data services 225 returns generalized insights through the generalized insights return step 227 to the spoke agent 210. The spoke agent 210 performs the complex task delegation step 214 to delegate tasks exceeding local reasoning capability to the hub complex models 220. The hub complex models 220 returns complex reasoning results through the complex reasoning results return step 221 to the spoke agent 210. The spoke agent 210 performs the context fusion step 222 to fuse local and global context. The spoke agent 210 delivers a consolidated response through the consolidated response delivery step 208 to the user 205. The delegation mechanism allows the spoke agent 210 to initiate a request for assistance when encountering a task that exceeds local model reasoning capability such as root-cause analysis involving historical data from multiple sites or compliance checks against global standards. The hub complex models 220 runs more complex and sophisticated reasoning models with high-parameter foundation models that specialize in generalized problem-solving, deep pattern recognition, and complex data correlation across diverse data streams.

FIG. 3 illustrates the deployment form factors 300 comprising the simple edge spoke 305, the connectors 310, the distilled focused AI model 315, the AI agents 320, the local data storage 325, the complex edge spoke 335, the connectors 340, the distilled focused AI model 345, the AI agents 350, the local data storage 355, the distributed storage layer 360, the site-wide data fabric 365, the metadata and compliance services 370, the central hub 375, the PrivateLink connectivity 380, the agent discovery and orchestration service 385, the user query 390, the hub agents 395, and the consolidated response 397. The simple edge spoke 305 is configured as a lightweight, dedicated edge processor focused on real-time validation and timing for short, multi-step machine operations. The simple edge spoke 305 includes the connectors 310 for sensor and IoT data streams, the distilled focused AI model 315, the AI agents 320 configured for real-time validation and timing operations, and the local data storage 325 functioning as a site data-fabric node. The complex edge spoke 335 is configured to monitor multi-day, human-in-the-loop processes like batch drug production to ensure end-to-end quality assurance, manage sequencing, and ensure regulatory compliance. The complex edge spoke 335 includes the connectors 340 for sensor and IoT data streams, the distilled focused AI model 345, the AI agents 350 configured for quality assurance, sequencing, and compliance tracking operations, and the local data storage 355 functioning as a site data-fabric node. The AI models deployed at the spoke are smaller, distilled, or quantized versions of larger models to reduce the computational footprint and enable deployment on resource-constrained edge hardware. The local data storage 325 and the local data storage 355 connect to the site-wide data fabric 365 comprising the distributed storage layer 360 and the metadata and compliance services 370. The distributed storage layer 360 connects to the central hub 375 through the PrivateLink connectivity 380. The central hub 375 includes the agent discovery and orchestration service 385 that receives the user query 390 and coordinates processing. The agent discovery and orchestration service 385 passes requests to the hub agents 395 that generate the consolidated response 397. The local contextual data store at the spoke is implemented as a fast database or time-series database optimized for storing recent, high-volume operational data. Human-generated data such as manual inspection reports, maintenance journals, operational notes, and shift logs are accurately digitized, captured, and structured for integration into AI model training and inference pipelines.

FIG. 4 illustrates the hub and spoke architecture 400 comprising the first spoke edge site 402, the local inference AI agents 405, the second spoke edge site 407, the compliance AI agents 410, the central hub 412, the secure communication gateway 414, the private link termination module 415, the encrypted data flow module 417, the rate limiting module 420, the agent orchestration module 422, the secure query routing module 424, the meta-agent grading module 426, the unified answer consolidation module 428, the multi-tenant isolation layer 430, the logical separation module 432, the authentication enforcement module 434, the centralized logging module 436, the global data aggregation layer 440, the aggregated data summaries module 445, the external data sources module 447, the vector database module 448, the foundation model hosting layer 450, the foundation models module 452, the GPU compute infrastructure 455, the model lifecycle management module 457, and the end-user client application 460. The first spoke edge site 402 contains the local inference AI agents 405 for local inference and validation tasks. The second spoke edge site 407 contains the compliance AI agents 410 for compliance, sequencing, and quality assurance operations. The central hub 412 includes the secure communication gateway 414 comprising the private link termination module 415, the encrypted data flow module 417, and the rate limiting module 420. The secure communication gateway 414 implements rate limiting and traffic management to ensure system stability under high load. The agent orchestration module 422 includes the secure query routing module 424 that routes user queries to appropriate spokes based on tenant ID, data relevance, and required latency. The agent orchestration module 422 includes the meta-agent grading module 426 and the unified answer consolidation module 428. The multi-tenant isolation layer 430 includes the logical separation module 432, the authentication enforcement module 434, and the centralized logging module 436. The global data aggregation layer 440 includes the aggregated data summaries module 445, the external data sources module 447, and the vector database module 448. The foundation model hosting layer 450 includes the foundation models module 452, the GPU compute infrastructure 455, and the model lifecycle management module 457. The foundation model hosting layer 450 includes dedicated server clusters with advanced cooling unsuitable for spoke locations. The model lifecycle management module 457 provides version control, deployment, and performance monitoring of the foundation models. The end-user client application 460 connects to the central hub 412 for submitting queries and receiving consolidated responses. The secure communication module at the spoke handles encrypted, authenticated, and asynchronous store-and-forward communication with the central hub 412. The system supports edge computing to keep highly sensitive operational data within local network boundaries for security and compliance reasons related to data sovereignty.

FIG. 5 illustrates the hub-spoke AI agent deployment system 500 comprising the additional edge spoke module 502, the factory systems module 505, the specialized agents module 507, the agent chain module 510, the user query 512, the central hub cloud 515, the agent discovery service module 517, the hub agent orchestration module 518, the consolidated response generator 520, the factory floor spoke module 522, the factory systems 525, the agent chain 527, the low-latency decision-making agent 530, the data curation agent 532, the model compression agent 535, the consolidated response output 540, the IoT devices spoke module 550, the retrieval agent chain 552, the factory systems component 555, the low-latency decision agent 557, the feature engineering agent 560, and the optimization agent 565. The central hub cloud 515 receives the user query 512 at the agent discovery service module 517 that connects to the hub agent orchestration module 518. The hub agent orchestration module 518 passes processed data to the consolidated response generator 520 that produces the consolidated response output 540. The additional edge spoke module 502 includes the factory systems module 505, the specialized agents module 507, and the agent chain module 510 that transmits data to the hub agent orchestration module 518. The factory floor spoke module 522 includes the factory systems 525, the agent chain 527, the low-latency decision-making agent 530, the data curation agent 532, and the model compression agent 535. The factory systems 525 connects to the low-latency decision-making agent 530 that passes data to the data curation agent 532 that connects to the model compression agent 535. The IoT devices spoke module 550 includes the retrieval agent chain 552, the factory systems component 555, the low-latency decision agent 557, the feature engineering agent 560, and the optimization agent 565. The local data ingestion layer at the spoke collects high-frequency data from diverse local sources including SCADA systems, industrial controllers, sensors, and manually entered production logs. The spoke agents perform data curation tasks including pre-processing raw sensor data, structuring unstructured manual records such as maintenance notes, and extracting features locally to reduce data volume transmitted to the hub. The spoke agents perform immediate data pre-processing tasks including time-series aggregation and anomaly detection on the edge compute unit. The edge computing unit at the spoke is implemented as a specialized, hardened computing appliance designed for industrial environments with TPUs for hosting the inference engine. The agent runtime environment at the spoke is implemented as a containerized or virtualized environment tailored for running specialized, compressed GenAI models and AI agents with minimal resource utilization. The spoke agents access tools that call into hub data services to consume and utilize aggregated and generalized data synthesized from across the entire network including global performance benchmarks, network-wide anomaly trends, and generalized operational insights. The cloud layer hosts large-scale global foundation models fine-tuned for industry-specific operations and performs model fine-tuning and global data aggregation from external sources and research archives. The system addresses network latency and bandwidth constraints where pushing massive amounts of raw high-frequency data to a central cloud location introduces unacceptable latency for real-time control applications.

The system can be further described as a distributed system for deploying and operating generative artificial intelligence applications within constrained industrial environments, comprising:
a. a central hub located in a centralized data center, the central hub configured to host a foundation model hosting layer including compute infrastructure for executing foundation models, to host a global data aggregation layer for storing and indexing global contextual data and aggregated summaries from a plurality of spoke locations, and to host an agent orchestration module configured to route user queries and to grade, synthesize, and consolidate responses received from a plurality of spokes;
b. a plurality of decentralized spokes, each spoke located at an industrial site and configured to host a local data ingestion layer for collecting operational data from local sources, to host an edge compute unit configured to execute inference for lightweight AI agents, and to host a local contextual data store for storing operational data to enable low-latency inference by the lightweight AI agents; and
c. an authenticated private link connecting each spoke of the plurality of decentralized spokes to the central hub, the authenticated private link configured to provide secure, encrypted data transfer for inference requests and responses between each spoke and the central hub.

The distributed system of the current disclosure, wherein the lightweight AI agents deployed at each spoke are configured to perform low-latency decision-making directly on real-time edge data for predictive maintenance and quality checks.

The distributed system of the current disclosure, wherein the lightweight AI agents are further configured to execute an agent chain encompassing local data retrieval, ranking, and evaluation before transmitting a compressed response to the central hub.

The distributed system of the current disclosure, wherein the lightweight AI agents utilize compressed, distilled, or quantized versions of the foundation models to execute inference with reduced computational overhead on the edge compute unit.

The distributed system of the current disclosure, wherein the lightweight AI agents are configured to access local tooling to interface with real-time local data and to call into data services at the central hub to consume aggregated global contextual data.

The distributed system of the current disclosure, wherein the central hub further comprises a multi-tenant isolation layer configured to enforce logical and computational separation of data and requests originating from different industrial site tenants.

The distributed system of the current disclosure, wherein the multi-tenant isolation layer is further configured to manage user authentication and authorization to ensure users access generative AI results derived from permitted spoke data.

The distributed system of the current disclosure, wherein the multi-tenant isolation layer is further configured to provide centralized logging, auditing, and compliance reporting across all connected spokes.

The distributed system of the current disclosure, further comprising an asynchronous communication module configured to utilize a store-and-forward mechanism at each spoke to buffer non-time-critical data transfer during network outages.

The distributed system of the current disclosure, wherein the global data aggregation layer comprises a vector database configured to support retrieval-augmented generation queries by indexing global documents and insights from the plurality of spoke locations.

A method for utilizing generative artificial intelligence in a multi-tenant industrial environment, comprising:
a. ingesting, at a spoke located at an industrial site, operational data from local sources using a local data ingestion layer;
b. executing, by lightweight AI agents at the spoke, local inference on time-sensitive requests using a local contextual data store to achieve low-latency responses;
c. delegating, by a lightweight AI agent at the spoke, a complex task to a central hub when the complex task exceeds a local reasoning capability of the lightweight AI agent, wherein delegating comprises transmitting relevant local context to the central hub through an authenticated private link;
d. receiving, at the central hub, a user query and routing the user query to one or more appropriate spokes based on tenant identification;
e. receiving, at the central hub, responses from spoke agents at the one or more appropriate spokes; and
f. executing, at the central hub, a meta-agent to grade and consolidate the responses from the spoke agents and to generate a unified answer for the user query.

The method of the current disclosure, further comprising pre-processing, by the lightweight AI agents at the spoke, the operational data to structure unstructured manual records and to extract features from the operational data, thereby reducing a data volume transmitted to the central hub.

The method of the current disclosure, wherein pre-processing the operational data comprises digitizing handwritten maintenance journals and shift logs for integration into AI model inference pipelines.

The method of the current disclosure, wherein routing the user query to the one or more appropriate spokes is further based on data relevance and required latency.

The method of the current disclosure, further comprising:
a. requesting, by the lightweight AI agent at the spoke, aggregated global context from data services at the central hub; and
b. fusing, by the lightweight AI agent, the aggregated global context with local context obtained from the local contextual data store to generate a hybrid response.

The method of the current disclosure, wherein the complex task comprises root-cause analysis involving historical data from multiple industrial sites or compliance checks against global standards.

A non-transitory computer-readable medium storing instructions that, when executed by one or more processors, cause the one or more processors to perform operations comprising:
a. receiving, at a central hub, a user query directed to a distributed generative artificial intelligence system comprising a plurality of spokes located at industrial sites;
b. routing, by an agent orchestration module at the central hub, the user query to one or more spokes of the plurality of spokes based on tenant identification and data relevance;
c. receiving, at the central hub through authenticated private links, responses from lightweight AI agents deployed at the one or more spokes, wherein each lightweight AI agent is configured to execute local inference using a distilled version of a foundation model and to access local operational data from a local contextual data store;
d. grading, by a meta-agent at the central hub, the responses received from the lightweight AI agents;
e. consolidating, by the meta-agent, the graded responses into a unified answer; and
f. transmitting the unified answer to a user.

The non-transitory computer-readable medium of the current disclosure, wherein routing the user query to the one or more spokes is further based on required latency to meet response time constraints for real-time control applications.

The non-transitory computer-readable medium of the current disclosure, wherein the operations further comprise enforcing, by a multi-tenant isolation layer at the central hub, logical and computational separation of data and requests originating from different industrial site tenants.

The non-transitory computer-readable medium of the current disclosure, wherein the operations further comprise managing, by the multi-tenant isolation layer, user authentication and authorization to ensure the user accesses generative AI results derived from permitted spoke data associated with the tenant identification.

Referring now to the drawings FIGS. 1-5, and more particularly to FIG. 1, there is shown a deployment structure 100, comprised of Cloud Provider 110, Central Hub 115 and the Cloud Provider 110 and Central Hub 115 are connected by direct connection 112. The Central Hub 115 is connected to Spoke 1 120, Spoke 2 125, Spoke 3 130 and Spoke 4 135 by Private link 140 which transfers Agent to Model, Agent to Agent and Model to Tool data, Private link 145 which transfers Agent to Model data, Private link 150 which transfers Agent to Agent data and Private link 155 which transfers Model to Tool data

FIG. 2 shows the interaction, or handshake, between the AI agents at the Spoke and their connection to the Hub 200. The user 205 submits task 206 (simple and complex) to Spoke agent 210. Spoke agent 210 access real time data, logs, device status 211 from Local Tools and Data 215. Local Tools and Data 215 returns local context 212 to Spoke agent 210 and Spoke agent 210 executes simple task locally (low-latency decision and validation 213. Spoke agent 210 delegate complex task (root-cause analysis compliance check 214 to Hub (Complex Models) 220 and Hub (Complex Models) 220 returns complex reasoning results 221 to Spoke agent 210 and Spoke agent 210 Fuse local and global context 222. Spoke agent 210 delivers consolidated response 208 to User 205. Spoke agent 210 request aggregated/global context (benchmarks, anomaly trends) 226 to Hub Data 225 and Hub Data 225 returns generalized insights 227.

FIG. 3 shows the deployment form factors 300 flow chart which comprises of the following:

Spoke: Simple Edge 305 first step is Connectors) (Sensors/IoT Data Stream) 310, which then Distilled Focus AI model 315 then AI Agents (Real Time Validation and Timing) 320, then Local Data Storage (Site Data-Fabric Node) 325.

And the Spoke: Complex edge 335 first step is Connectors) (Sensors/IoT Data Stream) 340, which then Distilled Focus AI model 345 then AI Agents (Quality assurance, Sequencing, compliance tracking) 350, then Local Data Storage (Site Data-Fabric Node) 355.

Local Data Storage (Site Data-Fabric Node) 325 and Local Data Storage (Site Data-Fabric Node) 355 the transfers to Distributed Storage Layer 360 which is within the Site-wide Data Fabric process 365 which also contains the Metadata and Compliance services process 370.

Distributed Storage Layer 360 transfers to PrivateLink Connectivity 380 which is in the Central Hub (cloud) 375.

PrivateLink Connectivity 380 transfers to the Agent Discovery and outreach service 385 which also receives User Query 390.

Agent Discovery and outreach service 385 transfers to Hub Agents: Grading and Consolidation 395 which transfers to Consolidated response to user 397.

FIG. 4 shows the central processing Hub and distributed Agents located in Spokes 400. Spoke: edge site 402 has AI agents (Local inference, Validation) 405 module.

Spoke: edge site 407 has AI agents (Compliance Sequencing, Quality Assurance) 410 module

Spoke: edge site 407 has AI agents (Local inference, Validation) 410 module.

AI agents (Local inference, Validation) 405 module and AI agents (Compliance Sequencing, Quality Assurance) 410 module, Central Hub (Brain of Multi-Tennant) 412 module which has a secure Communication Gateway 414 and Private Link Termination from spokes 415, Encrypted High-throughput data flow 417 module, Rate limiting and traffic management 420 module

Central Hub (Brain of Multi-Tennant) module 412 transfers data to Agent Orchestration and Routing Module 422 which has Secure Query Routing (Tenant ID, Latency and Relevance) module 424 module, Meta-Agent: Grading and Synthesizing response module 426 and Unified Answer Consolidation module 428.

Agent Orchestration and Routing Module 422 passes data to Multi-Tenent isolation and governance layer 430 having Logical and computational separation module 432, AuthN/AuthZ Enforcement module 434, Centralized Logging Auditing, Compliance and reporting module 436.

Agent Orchestration and Routing Module 422 passes data to Global data aggregation contextualization layer 440 which has Aggregation data summaries spokes 445, External Data Sources (Research, Benchmarks, Supply Chain) module 447, Vector Database for RAG Queries module 448.

Global data aggregation contextualization layer 440 passes data to Foundation Model (FM) hosting layer 450 which has Industry specific Foundation Modules (LLM) module 452, High-capacity GPU/Compute Infrastructure module 455 and Model Lifecycle management (Versioning, Development, Monitoring) module 457

Agent Orchestration and Routing Module 422 passes data to End-User/Client Application module 460 and End-User/Client Application module 460 passes data to Central Hub (Brain of Multi-Tennant) module 412.

As shown in FIG. 5 the Hub-Spoke AI Agent Deployment with Data Fabric 500 comprises:

Spoke: additional edge module 502 which has Factory Systems (Sensors, PLC's and Machines) module 505, Specialized Agents (Domain-Specific Tasks) module 507 and Agent Chain: Retrieval, Ranking and evaluation module 510. Agent Chain: Retrieval, Ranking and evaluation module 510 passes data to Hub Agent: Orchestration and grading module 518

User query 512 passes data to the central hub cloud 515 having Agent discovery service module 517 which passes data to Hub Agent: Orchestration and grading module 518 which passes data to Consolidated Response generator 520. Consolidated Response generator 520 pass data to Consolidated response to User module 540.

The spoke: factory floor/IoT devices module 522 comprises: Factory Systems (Sensors, PLC's machines) 525 and. Agent Chain: Retrieval, Ranking and evaluation module 527 which passes data to Hub Agent: Orchestration and grading module 518.

Factory Systems (Sensors, PLC's machines) 525 passes data to Low-Latency Decision Making agent 530 which passes data to Data curation and feature engineering agent module 532.

Data curation and feature engineering agent module 532 passes data to Model Compression and Optimization agent 535.

Spoke: factory floor IoT devices module 550 comprises Agent chain: retrieval, ranking and evaluation model 552 which passes data to Hub Agent: Orchestration and grading module 518, Factory systems (sensors, PLCs and machines module 555.

Factory systems (sensors, PLCs and machines module 555 passes data to Low-latency decision making agent module 557, Data curation and feature engineering agent module 560 and Model compression and optimization agent module 565.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments; it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

I claim:

1. A distributed system for deploying and operating generative artificial intelligence applications within constrained industrial environments, comprising:
a central hub located in a centralized data center, the central hub configured to host a foundation model hosting layer including compute infrastructure for executing foundation models, to host a global data aggregation layer for storing and indexing global contextual data and aggregated summaries from a plurality of spoke locations, and to host an agent orchestration module configured to route user queries and to grade, synthesize, and consolidate responses received from a plurality of spokes;
a plurality of decentralized spokes, each spoke located at an industrial site and configured to host a local data ingestion layer for collecting operational data from local sources, to host an edge compute unit configured to execute inference for lightweight AI agents, and to host a local contextual data store for storing operational data to enable low-latency inference by the lightweight AI agents; and
an authenticated private link connecting each spoke of the plurality of decentralized spokes to the central hub, the authenticated private link configured to provide secure, encrypted data transfer for inference requests and responses between each spoke and the central hub.

2. The distributed system of claim 1, wherein the lightweight AI agents deployed at each spoke are configured to perform low-latency decision-making directly on real-time edge data for predictive maintenance and quality checks.

3. The distributed system of claim 2, wherein the lightweight AI agents are further configured to execute an agent chain encompassing local data retrieval, ranking, and evaluation before transmitting a compressed response to the central hub.

4. The distributed system of claim 3, wherein the lightweight AI agents utilize compressed, distilled, or quantized versions of the foundation models to execute inference with reduced computational overhead on the edge compute unit.

5. The distributed system of claim 1, wherein the lightweight AI agents are configured to access local tooling to interface with real-time local data and to call into data services at the central hub to consume aggregated global contextual data.

6. The distributed system of claim 1, wherein the central hub further comprises a multi-tenant isolation layer configured to enforce logical and computational separation of data and requests originating from different industrial site tenants.

7. The distributed system of claim 6, wherein the multi-tenant isolation layer is further configured to manage user authentication and authorization to ensure users access generative AI results derived from permitted spoke data.

8. The distributed system of claim 7, wherein the multi-tenant isolation layer is further configured to provide centralized logging, auditing, and compliance reporting across all connected spokes.

9. The distributed system of claim 1, further comprising an asynchronous communication module configured to utilize a store-and-forward mechanism at each spoke to buffer non-time-critical data transfer during network outages.

10. The distributed system of claim 1, wherein the global data aggregation layer comprises a vector database configured to support retrieval-augmented generation queries by indexing global documents and insights from the plurality of spoke locations.

11. A method for utilizing generative artificial intelligence in a multi-tenant industrial environment, comprising:
ingesting, at a spoke located at an industrial site, operational data from local sources using a local data ingestion layer;
executing, by lightweight AI agents at the spoke, local inference on time-sensitive requests using a local contextual data store to achieve low-latency responses;
delegating, by a lightweight AI agent at the spoke, a complex task to a central hub when the complex task exceeds a local reasoning capability of the lightweight AI agent, wherein delegating comprises transmitting relevant local context to the central hub through an authenticated private link;
receiving, at the central hub, a user query and routing the user query to one or more appropriate spokes based on tenant identification;
receiving, at the central hub, responses from spoke agents at the one or more appropriate spokes; and
executing, at the central hub, a meta-agent to grade and consolidate the responses from the spoke agents and to generate a unified answer for the user query.

12. The method of claim 11, further comprising pre-processing, by the lightweight AI agents at the spoke, the operational data to structure unstructured manual records and to extract features from the operational data, thereby reducing a data volume transmitted to the central hub.

13. The method of claim 12, wherein pre-processing the operational data comprises digitizing handwritten maintenance journals and shift logs for integration into AI model inference pipelines.

14. The method of claim 11, wherein routing the user query to the one or more appropriate spokes is further based on data relevance and required latency.

15. The method of claim 11, further comprising:
requesting, by the lightweight AI agent at the spoke, aggregated global context from data services at the central hub; and
fusing, by the lightweight AI agent, the aggregated global context with local context obtained from the local contextual data store to generate a hybrid response.

16. The method of claim 11, wherein the complex task comprises root-cause analysis involving historical data from multiple industrial sites or compliance checks against global standards.

17. A non-transitory computer-readable medium storing instructions that, when executed by one or more processors, cause the one or more processors to perform operations comprising:
receiving, at a central hub, a user query directed to a distributed generative artificial intelligence system comprising a plurality of spokes located at industrial sites;
routing, by an agent orchestration module at the central hub, the user query to one or more spokes of the plurality of spokes based on tenant identification and data relevance;
receiving, at the central hub through authenticated private links, responses from lightweight AI agents deployed at the one or more spokes, wherein each lightweight AI agent is configured to execute local inference using a distilled version of a foundation model and to access local operational data from a local contextual data store;
grading, by a meta-agent at the central hub, the responses received from the lightweight AI agents;
consolidating, by the meta-agent, the graded responses into a unified answer; and
transmitting the unified answer to a user.

18. The non-transitory computer-readable medium of claim 17, wherein routing the user query to the one or more spokes is further based on required latency to meet response time constraints for real-time control applications.

19. The non-transitory computer-readable medium of claim 18, wherein the operations further comprise enforcing, by a multi-tenant isolation layer at the central hub, logical and computational separation of data and requests originating from different industrial site tenants.

20. The non-transitory computer-readable medium of claim 19, wherein the operations further comprise managing, by the multi-tenant isolation layer, user authentication and authorization to ensure the user accesses generative AI results derived from permitted spoke data associated with the tenant identification.
